(19) United States
(12) Patent Application Publication
(10) Pub. No.: US 2009/0106815 A1
(43) Pub. Date: Apr. 23, 2009

(54) METHOD FOR MAPPING PRIVACY POLICIES TO CLASSIFICATION LABELS

(75) Inventors: Carolyn A. Brodie, Briarcliff, NY (US); Richard H. Guski, Red Hook, NY (US); Clare-Marie N. Karat, Greenwich, CT (US); John Karat, Greenwich, CT (US); Peter K. Malkin, Ardsley, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/877,208

(22) Filed: Oct. 23, 2007

(51) Int. Cl. G06F 21/00

(52) U.S. Cl. 726/1

(57) ABSTRACT

A method and system are disclosed for mapping a privacy policy into classification labels for controlling access to information on a computer system or network, said privacy policy including one or more rules for determining which users can access said information. The method comprises the steps of parsing said one or more rules of the privacy policy; sorting the one or more rules into one or more sets; and, for each set of rules, (i) forming a logical statement from the rules of said each set, and (ii) using said logical statement to create associated privacy labels that allow access to said information. In a preferred embodiment, each of the rules is associated with a user category, a data category and a purpose category; and the rules in each set of rules have the same user category, the same data category, and the same purpose category.

### BACKGROUND OF THE INVENTION

1. Field of the Invention

This invention generally relates to information security within a computer system. More specifically, the invention relates to methods and systems for mapping privacy policies into classification labels that are used to enforce those policies.

2. Background Art

Advances in computing and communications technologies have contributed to an exponential growth in the number and frequency of electronic transactions or exchanges of digital data over computer networks. Privacy of data, and in particular data including personal identifiable information (PII) has become and continues to be a major concern for individuals, businesses, governmental agencies, and privacy advocates. Along with the growth in digital data exchanges has come an increased awareness and concern for the privacy of PII requested and/or required to complete the electronic data transaction and questioning of whether the PII data is or should be divulged to the requesting party.

Various businesses, regulatory organizations and consortiums have addressed the privacy of data in electronic transactions. A number of privacy policies have been proposed for adaptation to enhance the privacy of data during the electronic collection, storage, and dissemination of the data. The privacy policies tend to address privacy concerns related to the data that is general and/or specific in nature to a particular industry, business, or type of transaction. For example, privacy policy standards are being developed and/or have been published for data collection, storage, and dissemination related to financial transactions, the health care industry (e.g., medical records), and Wide World Web (i.e., the Web) data collection.

Traditionally, privacy policies have been implemented by using a relatively low-level set of controls, typically access control lists. That is, assuming individual users (persons or logical processes) are first identified and authenticated to a computing system in a satisfactory manner, their access to documents, programs, facilities, and other “objects” within the protected computer system is then controlled by a security system, for example a system security manager, simply by comparing the user's name against a list of names of persons entitled to access the given object. Generally speaking, this technique is known as discretionary access control or DAC.

According to a more sophisticated and well developed model for security of computer systems, access to objects in a computing system can be controlled by a logical system of compartmentalization implemented by way of logical security levels (which are hierarchical) and/or categories (which are not hierarchical) that are associated with users and protected computer resource objects. Such systems are referred to as “multilevel secure” (“MLS”) systems.

In MLS systems, users who are associated with (by assignment) the highest security levels and the largest numbers of categories are said to have the highest security levels in the system. Authority to read a protected object is granted to a user when the requesting user (after proper identification and authentication to the computing system) has an associated security level that is at least as high as that of the requested object and the user has a set of categories (one or more) that include those associated with the requested object. In this case, the user is said to “dominate” the object. Conversely, authority to write to an MLS protected object is granted to a user when the requested object has an associated security level that is at least as high as that of the requesting user and the object has a set of categories that include at least the categories that are associated with the requesting user. In this case the object is said to dominate the user. The MLS model is currently available, for example, within the program product Resource Access control Facility (RACF), which is an optional component of the z/OS operating system offered by the International Business Machine Corporation (IBM).

Known privacy systems, including MLS systems, thus provide measures for observing a privacy policy that outlines the access rights associated with data stored by the system. Procedures are not available though for automatically generating from a privacy policy privacy labels for controlling access to personal identifiable information.

### SUMMARY OF THE INVENTION

An object of this invention is to provide a method and system for generating privacy labels from a privacy policy.

Another object of the present invention is to map from a high-level privacy policy to privacy labels used for data access controls.

A further object of the invention is to determine automatically how to create the proper privacy labels for Purpose Serving Functions Sets (PSFS), users and data in order to enforce a given privacy policy or policies.

An object of this invention is to generate privacy labels from a high-level privacy policy for use on a system that is using the privacy labels approach to enforcing privacy policies.

These and other objectives are attained with a method and system for mapping a privacy policy into classification labels for controlling access to information on a computer system or network, said privacy policy including one or more rules for determining which users can access said information. The method comprises the steps of parsing said one or more rules of the privacy policy; sorting the one or more rules into one or more sets; and, for each set of rules, (i) forming a logical statement from the rules of said each set, and (ii) using said logical statement to create associated privacy labels that allow access to said information.

In a preferred embodiment, each of the rules is associated with a user category, a data category and a purpose category; and the sorting step includes the step of sorting the one or more rules into one or more sets, where each of the set of rules have the same user category, the same data category, and the same purpose category. Also, preferably, the forming step includes the step of forming the logical statement from all of the rules of said each set.

In addition, in the preferred embodiment of the invention, the logical statement is a disjunction of conjunctions, and the using step includes the step of using said conjunctions to create the associated privacy labels. The using step may also include the steps of, if the rules have a default of allowing access to the information, then (i) converting the logical statement to another logical statement having a default of denying access to the information, and (ii) using said another logical statement to create the associated privacy labels.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a computing environment in which the present invention may be implemented.

FIG. 2 is an illustrative block diagram showing an example of a Translation Server in one embodiment of the present invention.

FIG. 2A is a flow diagram illustrating flow control of a Translation Server in one embodiment of the present invention.

FIG. 3 is a flow diagram of the Logical Translation Handler in one embodiment of the present invention.

FIG. 4 is a flow diagram of the Privacy Label Creation Handler in one embodiment of the present invention.

FIG. 5 is a flow diagram of the Data Object Label Application Handler in one embodiment of the present invention.

FIG. 6 is a flow diagram of the Data User Label Application Handler in one embodiment of the present invention.

### DETAILED DESCRIPTION OF THE PREFERRED EMBODIMENTS

Presented herein is a data access control facility, which provides security for personally identifying information (PII). In accordance with this facility, access to PII information is based on various “conditions” that can exist (or be in effect) during or leading up to the execution of a computer process in which the access to the privacy classified computerized resource (broadly referred to herein as “object” or “data object”) occurs. Such conditions can include, but are not limited to: (1) the application function within which the user has requested access to the PII object; (2) how the user is identified and authenticated to the computing facility; (3) where the user is; (4) time of the request; (5) indication (e.g., a digitally signed agreement) that particular actions will be performed after the access occurs (e.g., that a given document containing PII will be destroyed after 5 years); and (6) other contextual and environmental factors that can be programmatically ascertained.

There are several ways in which conditions can be applied to any given access control checking event. For example, (1) privacy classification can be assigned to a user dynamically based on conditions that are in effect when the user attempts to access a PII sensitive object; or (2) privacy classifications to an object can instead (or also) be dynamically based on similar, sometimes the same, conditions. Thus, a data access control facility as presented herein advantageously allows a user, or computer process, access to different “sets” of PII classified objects, and functions, according to the dynamics of the access event situation, thereby adding flexibility to and enhancing the security of information processes that require access to personally identifying information.

Implementation of the data access control facility includes assigning personally identifying information (PII) classification labels to PII objects, with each PII object having one PII classification label assigned thereto. At least one PII purpose serving function set (PSFS) is defined and comprises a list of application functions that read, write, or reclassify PII data objects. A PII classification label is also assigned to each PSFS. When in use, a PII object may only be read via an application function of a PII PSFS having a PII classification label that is equal to or a subset of the PII classification label of the object, or may be written to only via an application function of a PII PSFS having: a PII classification label that is equal to or dominant of the PII classification label of the object, or having a list of PII reclassifications that are allowed by the PSFS.

Operationally, use of the data access control facility includes invoking, by a user of the computing application executing within the computing system, a particular function; determining whether the particular function is defined to a PSFS of the data access control facility, and if so, determining whether the user's PII clearance set (which comprises a list containing at least one PII classification label) includes a PII classification label matching the PII classification label assigned to that PSFS, and if so, allowing access to the particular function; and determining whether the user is permitted access to a selected object to perform the particular function. Thus, as explained further below, a PII data access control facility, in accordance with an aspect of the present invention, is employed to initially determine whether a user is entitled access to a particular function, and subsequently, whether the user is permitted access to a selected data object.

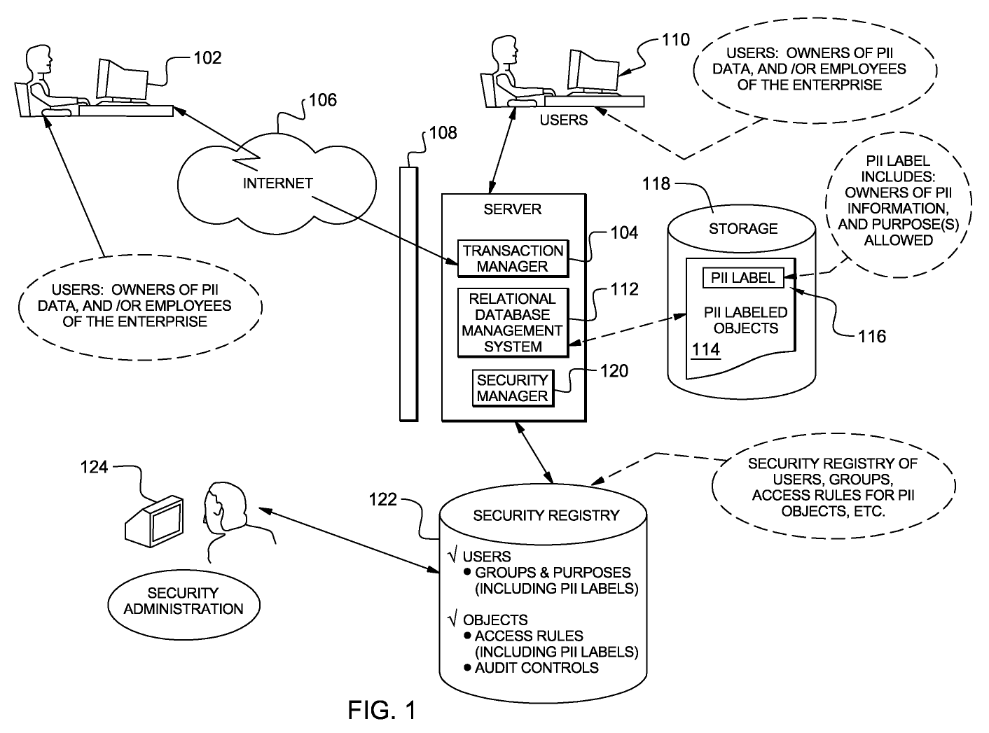

FIG. 1 depicts one example of an enterprise computing environment implementing a PII data access control facility such as disclosed herein. In this example, a user 102, such as an owner of PII data and/or an employee of the enterprise accesses a transaction manager 104, running on a server within the enterprise, from across the Internet 106, and through a firewall 108. Alternatively, users 110, inside firewall 108 could directly access the server containing transaction manager 104. A relational database management system 112, which also resides on the server in this example, accesses PII labeled objects 114 contained in tables 116 in an associated storage 118. Object storage 118 may take any desired form. A security manager 120, such as the above-referenced RACF offered by International Business Machines Corporation as an option for of the z/OS operating system, consults a security registry 122, which is maintained by the security administration 124 for the enterprise. Registry 122 may define users, including groups, and purposes, with associated PII labels, and may define object categories, including access rules, audit controls, etc.

Operationally, a user's request to the transaction manager to execute a particular function (which may or may not be defined within a PSFS) results in the creation of a “process” within the operating system. This can occur as the result of a request from a user who is connected to the computing system via the Internet or from a user who is locally connected, for example, an employee. The operating system platform security manager, which embodies the PII data access control facility, is invoked by the transaction manager to determine the user's authority to execute the requested function. Once approved, the function begins execution and subsequently, as part of its normal processing, generates a request via the transaction manager for (it is assumed) PII labeled data that is under the control of the relational database management system. The database management system invokes the security manager to determine whether the requesting user is permitted access to the desired PII object. The security manager renders a decision based, for example, on the PII label associated with the requested object, the PII label associated with the user, and other relevant access rules for the object. Again, the PII labels and other access rules can be established and maintained by a security administrator and stored on the security registry addressable by the security manager.

The present invention provides a method and system that enables the translation of a privacy policy into PII labels. The present disclosure also describes how the resulting PII labels may be applied to a given system's users and data objects, thereby implementing the original privacy policy.

In this description, the following standard logical notations will be used:

˜ for negation or NOT.

&& for conjunction or AND.

∥ for disjunction or OR.

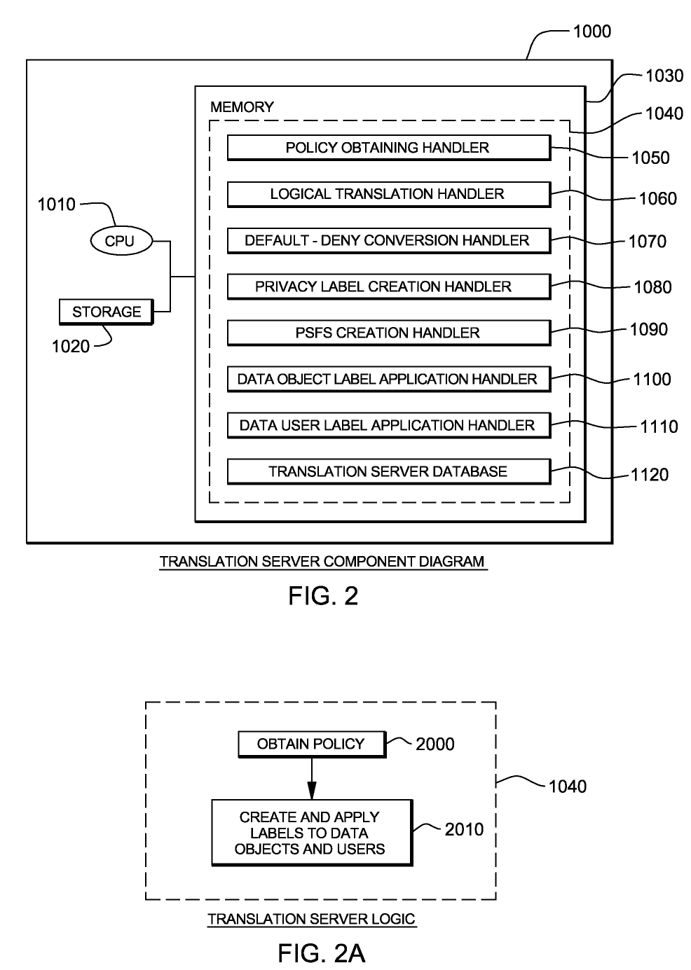

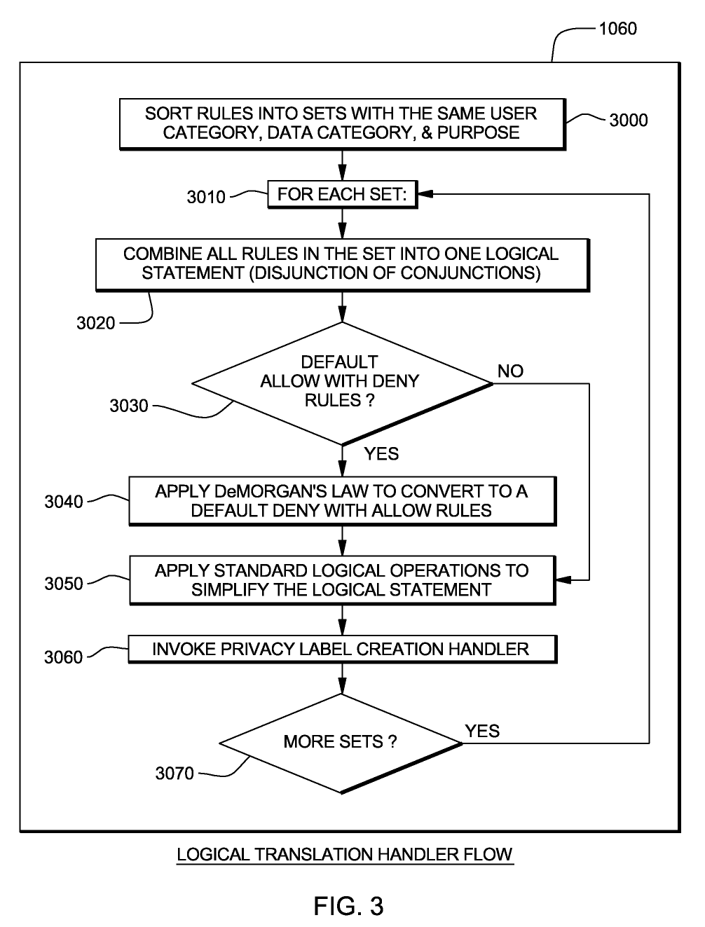

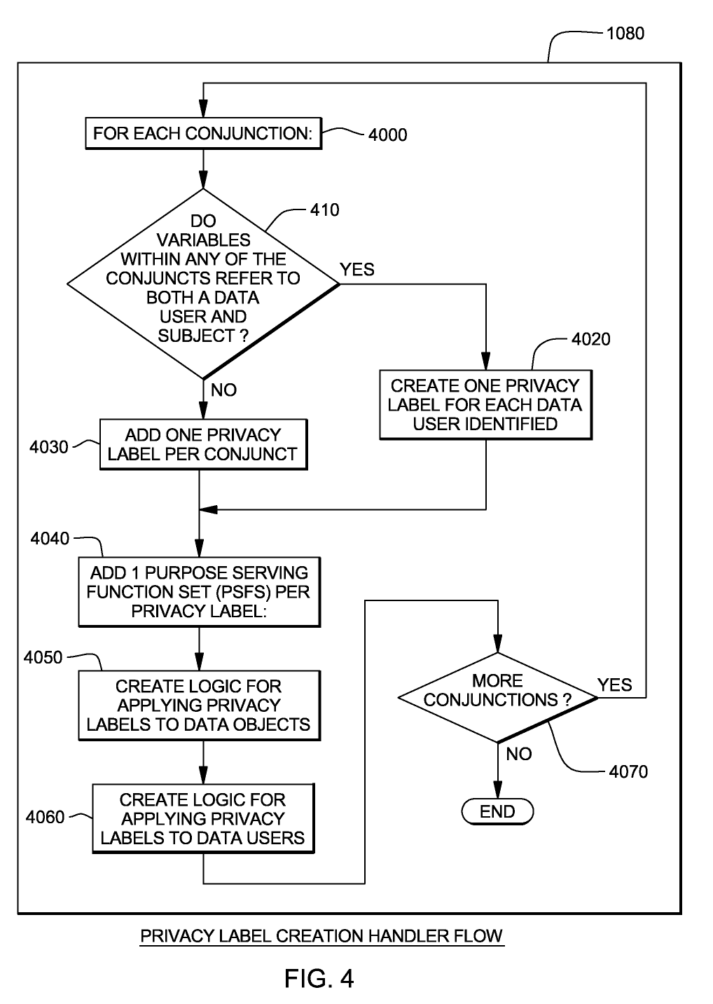

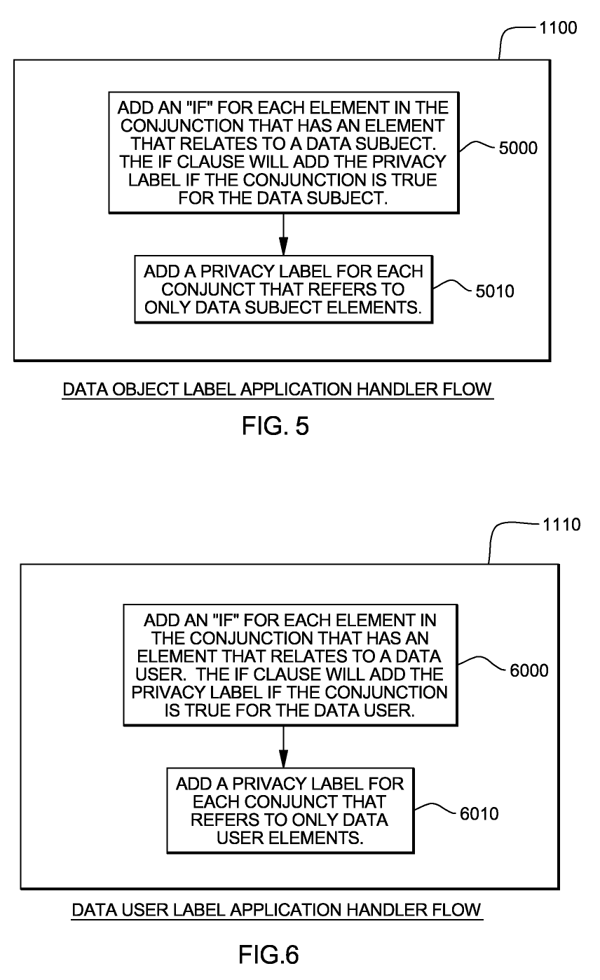

FIG. 2 shows a block diagram of a translation server 1000, in one embodiment of the present invention, which enables the translation of a privacy policy into PII labels. This system 1000 may comprise any computing node that is able to load and execute programmatic code, including, but not limited to: products sold by IBM such as ThinkPad® or PowerPC®, running the operating system and server application suite sold by Microsoft, e.g., Windows® XP, or a Linux operating system. System logic 1040 is preferably embodied as computer executable code that is loaded from a remote source (e.g., from a network file system), local permanent optical (CD-ROM), magnetic storage (such as disk), or storage 1020 into memory 1030 for execution by CPU 1010. As will be discussed in greater detail below, the memory 1030 preferably includes computer readable instructions, data structures, program modules and application interfaces forming the following components: a policy obtaining handler 1050, a logical translating handler 1060, described in detail with reference to FIG. 3, a default-deny conversion handler 1070, in detail with reference to FIG. 3, a privacy label creation handler 1080, described in detail with reference to FIG. 4, a PSFS creation handler 1090, described in detail with reference to FIG. 4, a data object label application handler 1100, described in detail with reference to FIG. 5, a data user label application handler 1110, described in detail with reference to FIG. 6, and a translation server database 1120. The translation server database 1120 in one embodiment provides for creation, deletion and modification of persistent data, and is used by the handlers 1050-1110 of the translation server 1000. An example of a product providing such function includes IBM DB/2 database system.

FIG. 2A is a flow diagram illustrating the control flow of the translation server's logic 1040 in one embodiment of the present disclosure. At step 2000, the policy-obtaining handler 1050 is invoked to parse the rules from a given policy. Although in the preferred embodiment, this policy is specified using the XACML (for details see: Extensible Access Control Markup Language (XACML) V1.014 OASIS Standard, 18 Feb. 2003, http://xml.coverpages.org/xacml.html) privacy profile, one of ordinary skill in the art will appreciate that alternative forms are also within the scope of the current invention, including, but not limited to a structured test, CIM-SPL (for details see: http://www.dmtf.org/standards/published_documents/DSP0231.pdf) and even another database. Every privacy policy rule that is read in is stored in the translation server database 1120 for access by other handlers (1060-1110). Next, in step 2010, the logical translation handler 1060, described in detail with reference to FIG. 3, is invoked. This handler 1060, then, both through its own logic, and through the help of the other handlers 1070-1110, takes the given policies, generates the corresponding privacy labels and purpose serving function sets (PSFS's), as well as calculating the logic required to apply the privacy labels to a given system's users and data. Note that all of the privacy labels, PSFS's and application logic are stored in the translation server database 1120. Once complete, the data and logic can then be used to apply the labels and PSFS's, said application being dependent on a given platform and its configuration (i.e., its user ID's, applications and system resource).

FIG. 3 is a flow diagram illustrating the control flow of the logical translation handler 1060, in one embodiment of the present invention. In step 3000, the rules are sorted into sets where each member rule has the same user category, data category and purpose. Each of these sets is saved in the translation server database 1120 in an association indicating the given set's user, data and purpose. Step 3010 is the start of a loop that processes each of the sets. The next unprocessed set is selected in step 3010 and then, in step 3020, all of the rules of the set are combined into one logical statement, a disjunction of conjunctions:

E.g.,
((A && B)∥(C && D)) then deny or
((A && B)∥(C && D)) then accept

Step 3030 checks whether the rules have a default of deny or accept. If the rules had a default of deny, then in step 3040, the new single local statement is passed to the default-deny conversion handler 1070, which uses DeMorgan's law to apply and distribute a negation through the statement, i.e., turning the statement into a conjunction of disjunctions:

E.g., ((˜A∥˜B) && (˜C∥˜D)) then accept

Next, the default-deny conversion handler 1070 uses standard logic's distribution to translate the conjunction of disjunctions into disjunction of conjunctions:

E.g., [(˜A && ˜C)∥(˜A && ˜D)]∥[(˜B && ˜C)∥(˜B && ˜D)] then accept

Once finished being processed by the default-deny conversion handler 1070, the rules use a deny default. Following this, or if the rules already had a deny default, the privacy label creation handler 1080 applies standard logical operations to simplify the statement:

E.g.,
Eliminating double negations: ˜(˜A)=>A,
Eliminating redundant conjuncts: (A && A)=>A and
Eliminating redundant disjuncts: (B∥B)=>B

One of ordinary skill in the art will appreciate that additional types of logical simplifications are possible as well, including but not limited to subsumption. Each of the (top-level) conjunctions of the simplified logical statement (a disjunction of conjunctions) is then written into the translation server database 1120, each conjunction being stored with an association to the same data user, data category and purpose as its source rules.

Finally the privacy label creation handler is invoked in step 3060. When that is complete, step 3070 checks whether there are further sets, returning to step 3010 if there are. If not, processing is complete.

FIG. 4 is a flow diagram illustrating the control flow of the privacy label creation handler 1080, in one embodiment of the present invention. It is this handler 1080, which uses the conjunctions calculated by the logical translation handler 1060 and stored in the translation server database 1120 to direct the creation of the associated privacy labels, PSFS's and label application logic. Step 4000 begins a loop, which processes each such conjunction. After obtaining the next unprocessed conjunction in step 4000—along with its associated data user, data category and purpose, which were stored in the database 1120 with the conjunction—the handler 1080 checks in step 4010 whether variables within any of the given conjunction's conjuncts refer to both the data user and data subject. An example of this would be a conjunct indicating the ability to prescribe medicine:

E.g., can_prescribe_medicine_to (<user>, <subject>)

If, so, then, in step 4020 the handler 1080 creates one privacy label for each data user identified (e.g., every user in the target system); otherwise, in step 4030, the handler 1080 creates one privacy label for each conjunction, these privacy labels all being stored in the translation server database 1120. Note that the process of creating privacy labels is well known in the art, for example, one suitable procedure is disclosed in U.S. Patent Application Publication No. 2003/0044409, the disclosure of which is herein incorporated by reference in its entirety. Following either step 4020 or 4030, control continues at step 4040 where the PSFS Creation Handler 1090 is invoked with the data user, data category and purpose associated with the current conjunction.

The PSFS Creation Handler 1090 is responsible for creating a PSFS which indicates all of the applications within a given system that allow the passed data user to access the passed data category for the passed purpose. Thus, a PSFS containing all of a given company's payroll applications might be created if the PSFS Creation Handler 1090 were passed data user's=accounting representatives, data category=accounting data, and purpose=accounting. One of ordinary skill in the art will appreciate that it is likely this would be handled by knowledgeable employees who are provided with the data user, data category and purpose for each requested PSFS. Once created, each new PSFS is stored in the translation server database 1120 with its own new unique name.

Following this, the data object label application handler 1100 is invoked in step 4050 (described in detail with reference to FIG. 5), followed by an invocation of the data user label application handler 1110 (described in detail with reference to FIG. 6), both handlers 1100 and 1110 being passed the current conjunction in steps 4050 and 4060 respectively. After this, step 4070 checks whether there are any further conjunctions to process. If so, control continues at step 4000; if not, the handler 1080 ends at step 4080.

FIG. 5 is a flow diagram illustrating the control flow of the data object label application handler 1100, in one embodiment of the present invention, and which is responsible for determining the logic required to apply the created privacy labels to a given system's data objects. As shown, step 5000 adds an “if” for each element in the conjunction that has an element that relates to a data subject. The if clause will add the privacy label if the conjunction is true for the data subject.

Step 5010 adds a privacy label for each conjunct that refers to only data subject elements. All data created by this handler 1100 is stored in the translation server database 1120.

FIG. 6 is a flow diagram illustrating the control flow of the data user label application handler 1110, in one embodiment of the present invention, which is responsible for determining the logic required to apply the created privacy labels to a given system's data users. As shown, step 6000 adds an “if” for each element in the conjunction that has an element that relates to a data user. The if-clause will add the privacy label if the conjunction is true for the data user.

Step 6010 adds a privacy label for each conjunct that refers to only data user elements. All data created by this handler 1100 is stored in the translation server database 1120

In the following example, the present invention is used to map an anti-spam policy to privacy labels.

Example Privacy Policy:
1. Default—Allow Access
2. If {purpose==initiate commercial advertising && data users==rep && data=mailing address && (recipient_state==CA && recipient_optin_data==False)} then deny access.
3. If {purpose==initiate commercial advertising && data users==rep && data=mailing address && (sender_state==CA && recipient_optIn_data==False)} then deny access.

Given this policy information and the assumptions (shown in parenthesis above), we will show how it is used to define privacy labels.

Sort rules so that we have all rules with the same purpose, data user and data category.

The first and second rules have the same purpose, data user and data category and also have conditionals. This logic works with the conditionals.

1. Create logical statements from rules. For ease of writing and reading, the following symbols will be used for the variables of the antecedent. Also included whether they are a function of the user or the subject:

i. Sender_state!=CA represented by A(user)
ii. Recipient_state!=CA represented by B(subject)
iii. Recipient_OptIn_Data==True represented by C(subject)

### [not B(subject) && not C(subject)]∥[not A(user) && not C(subject)]<=>Deny(com-adv)

Because this policy has a default allow with deny rules, we will use de Morgan's law to create a default deny with allow rules.

1. [B(subject)∥C(subject)] && [A(user)∥C(subject)]<=>Allow(Purpose com-adv)

Simplify the expression:

1. Turn into disjunction of conjunction using distribution
a. [B(subject) && A(user)]∥[B(subject) && C(subject)]∥[C(user) && A(user)]∥C(subject)<=>allow(Purpose com-adv)

2. Two conjuncts are subsumed by C(subject) so they are removed
a. [B(subject)&&A(user)]∥C(subject)<=>Allow (Purpose com-adv)

From the conjunction of disjunctions, create one privacy label for each conjunction.

1. NeitherSideInCA

2. SubjectOptIn

Define one Purpose Serving Function Set (PSFS) per privacy label:
1. PSFS 1—Commercial Advertising, neitherSideInCA—from here on this will be referred to as neitherSideInCA
2. PSFS 2—Commercial Advertising, subjectOptIn—from here on this will be referred to as subjectOptIn

Define Data User and Data Object (per subject) Labels:

Some important assumptions are made. Although, the IP discusses the possibility of creating PII classification labels in real time, for simplicity we will consider a solution in which the labels are created and the data users, PSFS's, and data (PII) objects are labeled at set intervals before data is being accessed. In this situation, data user labels must be computed without taking subject information into account. Likewise, data object (per subject) labels must be computed without taking data user information into account.

The final access decision is based on first making sure that the data user has the privacy label of a PSFS of the function being used. Once that is determined, the function can attempt to access the data object. This access is allowed only if the PSFS's label is either equal to or a proper subset of the data object's label.

So the idea is to generate logic for generating data users and data objects (per subject) labels from the logical statement constructed from the privacy rules such that when data is accessed the access decision reached using privacy labels matches the truth table for the logical statement. Thus for data users, labels are generated so that access is denied when something about the user makes the truth table entry false, but all labels that could be true depending on subject data only or in conjunction with data known about the user are added so that nothing about the data subject prevents the access at this point. Data subject labels are actually sets of individual labels so they must be appended together.

The same process is used for data items. Labels are generated so that the access is denied when something about the data subject makes the truth table entry a false, but labels are added so that nothing about the data user prevents the access at this point.

One way to do this is create an “if” statement based on each variable in the antecedent of the logic statement.

For this example, the following logic would be created:

Data User Labels (executed for each data user or category of data user)
/* Add label for location of data user—user not in CA */
If (a(user)) then {Add privacy label NeitherSideInCA}
/*make sure that no assumptions made about subjects so don't worry about where the data subject is—when the user labels are compared to the object labels this will be taken care of) */
Add privacy label SubjectOptIn
Data Object (per subject email address) Labels
/*Add for location of Data subject—Subject not in CA—don't make assumptions about data users that will be handled by the data user logic */
if (B(subject)) then {add privacy label NeitherSideInCA}
/* Add for opt-in status of subject—subject has opted in*/
if (C(subject)) then {add privacy label SubjectOptIn}

As will be readily apparent to those skilled in the art, the present invention, or aspects of the invention, can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of methods or procedures described herein, and which—when loaded in a computer system—is able to carry out those methods or procedures. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of mapping a privacy policy into classification labels for controlling access to information on a computer system or network, said privacy policy including one or more rules for determining which users can access said information, the method comprising the steps of:
parsing said one or more rules of the privacy policy;
sorting the one or more rules into one or more sets; and
for each set of rules,
forming a logical statement from the rules of said each set, and
using said logical statement to create associated privacy labels that allow access to said information.

2. A method according to claim 1, wherein:
each of the rules is associated with a user category, a data category and a purpose category; and
the sorting step includes the step of sorting the one or more rules into one or more sets, where each of the set of rules have the same user category, the same data category, and the same purpose category.

3. A method according to claim 1, wherein the forming step includes the step of forming the logical statement from all of the rules of said each set.

4. A method according to claim 1, wherein:
the logical statement is a disjunction of conjunctions; and
the using step includes the step of using said conjunctions to create the associated privacy labels.

5. A method according to claim 1, wherein the using step includes the steps of:
if the rules have a default of allowing access to the information, then
converting the logical statement to another logical statement having a default of denying access to the information, and
using said another logical statement to create the associated privacy labels.

6. A method according to claim 1, comprising the further step of defining one purpose serving function set (PSFS) per said created privacy labels, each of the PSFSs identifying all of the applications within a given system that allow defined users to access specified data for defined purposes.

7. A method according to claim 1, wherein said information includes a multitude of data objects, and comprising the further step of determining logic to apply the created privacy labels to said data objects.

8. A method according to claim 7, wherein the step of determining logic includes the step of using said conjunctions to determine which of the privacy labels to add to which of the data objects.

9. A method according to claim 1, for use with a plurality of users, and comprising the further step of determining logic to apply the created privacy labels to said users.

10. A method according to claim 9, wherein the step of determining logic includes the step of using said conjunctions to determine which of the privacy labels to add to which of the users.

11. A system for mapping a privacy policy into classification labels for controlling access to information on a computer system or network, said privacy policy including one or more rules for determining which users can access said information, the system comprising:
a translation server for parsing said one or more rules of the privacy policy; for sorting the one or more rules into one or more sets; and for each of said sets (i) forming a logical statement from the rules of said each set, and (ii) using said logical statement to create associated privacy labels that allow access to said information.

12. A system according to claim 11, wherein the translation server includes:
a policy obtaining handler to parse the rules from the privacy policy; and
a logical translation handler to generate the privacy labels and to calculate logic required to apply the generated privacy labels to data and users of the system.

13. A system according to claim 12, wherein the logical translation handler sorts the rules into sets, wherein for each set, all of the rules in the set have the same user category, data category and purpose.

14. A system according to claim 13, wherein, for each set, the logical translation handler combines all of the rules in said each set into one logical statement.

15. A system according to claim 14, wherein:
each of the logical statements is a disjunction of conjunctions; and
the translation server further includes a default deny conversion handler for converting selected ones of the logical statements to conjunctions of disjunctions.

16. A system according to claim 15, for use with a group of applications for accessing the information, and wherein the translation server further includes:
a privacy label creation handler to create, when predetermined conditions are satisfied, one processing label for each user in a target system; and
a purpose serving function set creation handler to create one or more purpose serving function sets (PSFSs) to indicate all of said applications that allow a given data user to access given data.

17. An article of manufacture comprising:
at least one computer usable medium having computer readable program code logic for mapping a privacy policy into classification labels for controlling access to information on a computer system, said privacy policy including one or more rules for determining which users have access to said information, the computer readable program code logic comprising:
parsing logic for parsing said one or more rules of the privacy policy;
sorting logic for sorting the one or more rules into one or more sets; and
translating logic for, from each set of rules, (i) forming a logical statement from the rules of said each set, and (ii) using said logical statement to create associated privacy labels that allow access to said information.

18. An article of manufacture according to claim 17, wherein:
each of the rules is associated with a user category, a data category and a purpose category; and
the sorting logic includes logic for sorting the one or more rules into one or more sets, where each of the set of rules have the same user category, the same data category, and the same purpose category.

19. An article of manufacture according to claim 18, wherein the translating logic includes logic for forming the logical statement from all of the rules of said each set.

20. An article of manufacture according to claim 19, wherein:
the logical statement is a disjunction of conjunctions;
the translation logic includes logic for using said conjunctions to create the associated privacy labels; and
the translation logic includes further logic for, if the rules have a default of allowing access to the information, then (i) converting the logical statement to another logical statement having a default of denying access to the information, and (ii) using said another logical statement to create the associated privacy labels.
